(19) United States
(12) Patent Application Publication
(10) Pub. No.: US 2009/0248267 A1
(43) Pub. Date: Oct. 1, 2009

(54) METHOD AND DEVICE FOR DISTANCE REGULATION OF A MOTOR VEHICLE

(76) Inventor: Juergen Boecker, Stuttgart (DE)

Correspondence Address: KENYON & KENYON LLP, ONE BROADWAY, NEW YORK, NY, 10004, US

(21) Appl. No.: 12/304,360

(22) PCT Filed: Sep. 5, 2007
(86) PCT No.: PCT/EP2007/059294

§ 371 Date: Dec. 11, 2008

(30) Foreign Application Priority Data
Nov. 3, 2006 (DE) 102006051961.2

(51) Int. Cl. B60W 30/16

(52) U.S. Cl. 701/70

(57) ABSTRACT

A method and a device are provided for distance regulation of a motor vehicle equipped with an object detection sensor which detects objects located in front and regulates the velocity of the host vehicle in the sense of distance regulation, the distance control system being able to brake the host vehicle to a standstill. If objects are no longer detected during the stopping process due to the fact that they are located within the invisible region in the immediate vicinity of the object detection sensor, object positions relating to the objects detected earlier are stored, and a starting process of the vehicle resulting from the driver's intention to start, implemented via an actuation and/or confirmation element, is prevented until the object is detected again. The restarting process is not prevented when a turning maneuver of the object located in front has been detected due to the fact that the absolute value of the transverse offset of the object located in front exceeds a predetermined threshold value.

### FIELD OF INVENTION

The present invention relates to a method and a device for distance regulation of a motor vehicle equipped with an object detection sensor which detects objects located in front and regulates the velocity of the host vehicle in the sense of distance regulation, the distance regulation system being able to brake the host vehicle to a standstill. If objects are no longer detected during the braking process because they are located within the invisible region in the immediate vicinity of the object detection sensor, object positions relating to the previously detected objects are stored, and a starting process of the vehicle resulting from a driver's intention to start, implemented via an actuating element, is prevented until the object is detected again. The restarting process is not prevented when a turning maneuver of the object located in front is detected due to the fact that the absolute value of the transverse offset of the object located in front exceeds a predetermined threshold value.

### BACKGROUND INFORMATION

A speed controller is described in German Patent Application DE 103 03 611 A1 having multiple operating modes which may be activated in different speed ranges and which differ in their functional scope, a change in the operating mode which results in loss of a safety-relevant function being possible only by an instruction from the driver. One of the provided operating states is an operating state in which the vehicle is automatically braked to a standstill and is automatically started again after instruction by the driver.

A speed controller is described in German Patent Application DE 103 20 722 A1 having a stop function for automatically braking the vehicle to a standstill, the controller having at least one standstill state in which the vehicle is maintained in a stopped state by automatic actuation of the brake, and from which a start may occur only following an operating instruction by the driver.

### SUMMARY OF THE INVENTION

An object of the present invention is to provide a method and a device for distance regulation of a motor vehicle, in which an object detection sensor is provided which illuminates objects present in the region in front of the host vehicle. It is possible that objects in stop-and-go operation may approach the host vehicle so closely that the objects disappear in the invisible region in the immediate vicinity of the object detection sensor and are no longer detectable for the stop-and-go situation, which may result in collisions when starting again. It is therefore provided that the starting process of the vehicle is prevented when one of the objects, which technically has been detected by the object detection sensor, disappears in the invisible immediate vicinity and is no longer detectable by the object detection sensor.

As a result of the device and the method according to the present invention, the system perceives the existence of these objects which are invisible to the sensor and prevents an automatic start of the vehicle as the result of a driver-actuated start instruction, thereby allowing possible collisions to be avoided. In this regard, it is advantageous that the object is no longer recognized as being detectable when it is located in the invisible region in the immediate vicinity of the object detection sensor. This may be recognized by the fact that the objects have previously been detected and their position determined, and that the system is aware that these objects have moved relative to the host vehicle, the distance from the objects having become increasingly smaller until the objects have “disappeared” in the invisible region in the immediate vicinity of the object detection sensor. Using a tracking algorithm in which the relative position as well as the relative motion of the previously detected object will be extrapolated in the future, and based on the knowledge of the velocity of the host vehicle, an appropriate location of the invisible object may be determined.

The present invention further provides for a starting process to be enabled again only when the object is at a sufficient distance from the object detection sensor, this distance advantageously corresponding to the detection limit. It is also advantageous that the vehicle does not start again until the driver activates an actuating and/or confirmation element by which a driver's intention to start is signaled and a check is made to determine whether an invisible object which is possibly present has been detected, and the detected object located in front is at a sufficient distance away or is removed from the host vehicle at a sufficiently large relative velocity so that a safe automatic start is possible.

It is also advantageous that the object detection sensor checks whether the objects located in front are completing a turning maneuver by determining the transverse offset of these objects. “Transverse offset” refers to the distance between the objects with respect to the extended longitudinal axis of the vehicle, i.e., with respect to the predicted driving route (lane). If an object located in front turns, this transverse offset of the object increases very rapidly during the turning maneuver until this transverse offset exceeds a quantitative threshold value and the object has disappeared from the detection range of the sensor. As a result of the monitoring of a possible turning maneuver of the object located in front, a decision may be made as to whether the object located in front is no longer detectable due to the fact that the object has passed into the invisible region in the immediate vicinity of the object detection sensor, or the object is no longer detectable because the object located in front has “disappeared” due to a turning maneuver.

It is also advantageous that the starting process is not prevented when a turning maneuver of the object located in front has been detected, and that it is ensured that the object is not located in the invisible region in the immediate vicinity of the object detection sensor, but instead has “disappeared” from the region in front of the vehicle, so that safe starting is possible.

It is also advantageous for the tracking as well as the turn recognition to be carried out even when the distance control is deactivated, so that current object data are already present when the distance controller is activated. If the distance controller did not generate object data until it had been activated by the driver, and if the distance controller was not activated until the standstill state when objects are already present in the invisible region in the immediate vicinity of the object detection sensor, these relevant objects which, however, are not detectable by the sensor, would be ignored, possibly resulting in collisions upon starting. It is therefore advantageous to continuously carry out the tracking as well as turn recognition during driving operations, although these data are not evaluated with regard to a possible intention of the driver to start until the distance controller has been activated by the driver.

The method according to the present invention may be implemented in the form of a control element which is provided for a control unit of an adaptive distance or speed regulation in a motor vehicle. A program which is able to run on a computing unit, in particular a microprocessor or signal processor, and which is suitable for carrying out the method according to the present invention may be stored on the control element. Thus, in this case the present invention may be implemented by a program stored on the control element, so that this control element provided with the program represents the present invention in the same way as the method, which the program is suitable for carrying out. An electrical storage medium, a read-only memory, for example, in particular may be used as the control element.

Further features, application possibilities, and advantages of the present invention result from the following description of exemplary embodiments of the present invention, which are illustrated in the figures of the drawing. All of the described or illustrated features, alone or in any given combination, represent the subject matter of the present invention.

### BRIEF DESCRIPTION OF THE DRAWINGS

FIG. 1 shows a block diagram of an exemplary embodiment of the device according to the present invention.

FIG. 2 shows a top view of a schematic driving situation for carrying out the method according to the present invention.

FIG. 3 shows a diagram for explaining the method according to the present invention.

### DETAILED DESCRIPTION OF THE INVENTION

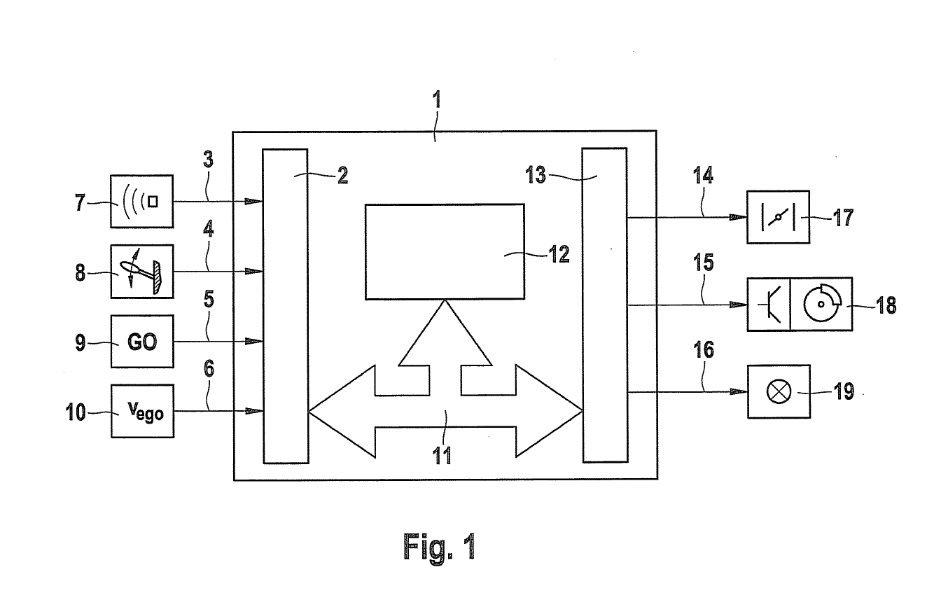

FIG. 1 shows a schematic illustration of the device according to the present invention. Shown is distance controller 1, which among other elements has an input circuit 2. By use of input circuit 2, input signals 3, 4, 5, 6 which originate from other units are supplied to distance controller 1. One of the input signals is the signal from an object detection sensor 7, which advantageously may be designed as a radar sensor. This sensor transmits microwave signals, in particular in the region in front of the host vehicle, and receives the partial waves reflected by objects and determines therefrom distance d, and additionally or alternatively determines the relative velocity (v_{obj}−v_{ego}) and relays these values to input circuit 2 of distance controller 1.

Also provided as a unit is a driver-actuatable control element 8 via which the driver may switch distance controller 1 on and off, as well as change settings and system parameters. Signals 4 generated by control unit 8 are likewise supplied to input circuit 2.

Also provided is a start confirmation element 9 via which the driver may communicate to the system an intention to start when distance controller 1 is activated. This start signal 5 is likewise supplied to input circuit 2, and is generated by an action of the driver.

Also provided is a velocity sensor 10 which is able to determine velocity v_{ego} of the host vehicle, and which supplies this vehicle velocity as a signal 6 to input circuit 2 of distance controller 1. Based on the knowledge of velocity v_{ego} of the host vehicle, the relative velocities (v_{obj}−v_{ego}) may be converted to absolute velocities v_{obj} and thus identify the absolute velocity of the preceding vehicles.

Input signals 3, 4, 5, 6 which are supplied to distance controller 1 via input circuit 2 are supplied to a computing unit 12 via a data exchange unit 11, which may be designed as a bus system, for example. Computing unit 12 may be designed as a microprocessor or microcomputer, for example, and may contain a control process which computes actuating signals from the supplied input variables, thereby carrying out a distance regulation. The actuating signals determined by computing unit 12 for the downstream actuating elements are output via a data exchange system 11, which may advantageously be designed as a bus system, to an output circuit 13, which in turn outputs the actuating signals to the corresponding downstream actuating elements. Thus, a torque request for a power-determining actuating element of an internal combustion engine 17 is provided as an output signal 14; the actuating element may be designed, for example, as an electrically actuatable throttle valve or a fuel metering unit of an accumulator injection system.

If an output signal is determined in computing unit 12 which provides that host vehicle 20 should be accelerated for distance regulation, a corresponding acceleration signal or a corresponding torque request is generated, which as an output signal 14 is supplied to the power-determining actuating element of internal combustion engine 17, and the vehicle is correspondingly accelerated. In addition, deceleration unit 18 of the vehicle is provided as a downstream actuating element, it being possible for deceleration signal 15 to be supplied to an electrically actuatable brake booster which converts a deceleration signal 15 to a braking pressure and relays same to the braking units of the vehicle wheels. If computing unit 12 determines that a deceleration of host vehicle 20 is necessary for distance regulation, a corresponding deceleration signal 15 is determined and is output to deceleration units 18.

Optionally provided as a further output signal 16 is the actuation of a warning device 19, which may be designed, for example, as a warning light in the visual field of the driver, in particular in the dashboard or in the center console. Warning light 19 is actuated by control signal 16 when the driver has activated control element 9 in order to communicate to distance controller 1 an intention to start; however, on the basis of the method according to the present invention distance controller 1 stops and prevents an automatic start of the vehicle, and the driver must be informed that the failure of vehicle 20 to start is not a malfunction, i.e., automatic starting must be prevented to avoid collisions due to an object in the immediate vicinity of object detection sensor 7.

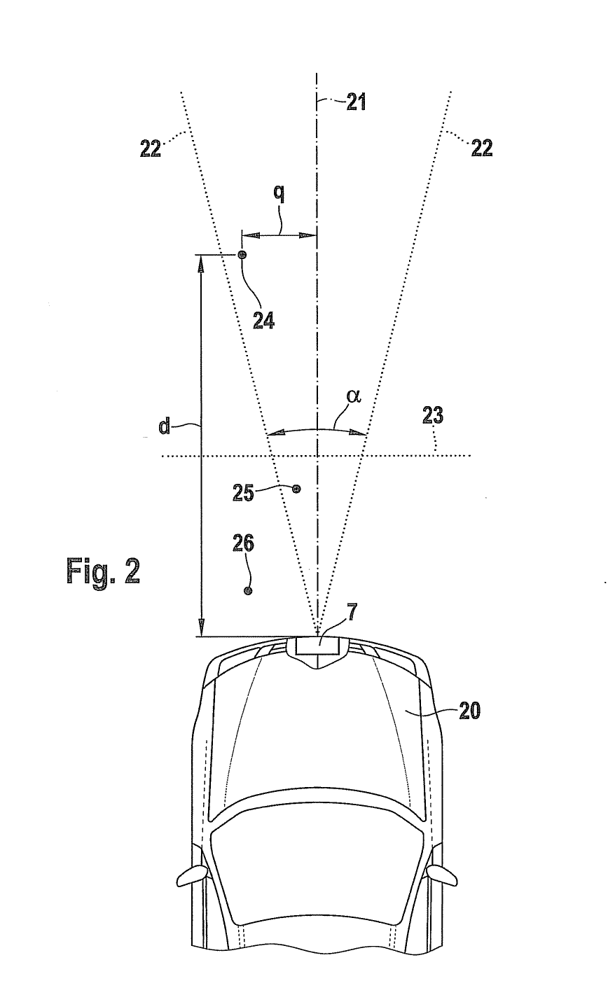

FIG. 2 shows a top view of a driving situation illustrating the host vehicle 20, which on the front side has an object detection sensor 7, in particular in the form of a radar sensor. Object detection sensor 7 is centrally installed on vehicle 20 and has a sensor detection region which is symmetrically situated with respect to extended longitudinal axis 21 of the vehicle. The sensor detection region also has an opening angle α, and expands in a sector-like pattern with increasing distance, the limits of sensor detection region 22 being indicated in the drawing. Objects 24, 25, 26, which may be present at different positions, are also schematically shown.

Illustrated perpendicular to extended longitudinal axis 21 of the vehicle is detection limit 23, which delineates the lower limit of the sensor detection region, i.e., minimum distance d in which object detection sensor 7 is able to detect objects. Object 24, which is at a greater distance d away than specified by detection limit 23, may accordingly be detected by object detection sensor 7. In contrast, although object 25 is located within the limits of sensor detection region 22, this object is closer to object detection sensor 7 than the distance specified by minimum detection limit 23. Object detection sensor 7 is therefore not able to detect object 25; i.e., object 25 is located within the invisible region in the immediate vicinity of object detection sensor 7. A third object 26 is also illustrated, which likewise is not detectable by object detection sensor 7 because the object is located outside the limits of sensor detection region 22.

If host vehicle 20 then moves behind a preceding vehicle, and the preceding vehicle brakes to a standstill, distance controller 1 likewise actuates deceleration unit 18 of host vehicle 20 in such a way that host vehicle 20 stops behind the preceding vehicle, which has been detected as object 24, and host vehicle 20 remains stopped. When the preceding vehicle resumes travel, the driver of host vehicle 20 must activate a start confirmation element 9, whereupon host vehicle 20 automatically starts again and follows preceding vehicle 24.

If the preceding vehicle then stops and host vehicle 20 approaches the preceding vehicle so closely that the preceding vehicle is detected as an object having a distance d that is less than detection limit 23, the preceding vehicle is no longer detectable by object detection sensor 7. If the driver then activates start confirmation element 9, distance controller 1 would accelerate host vehicle 20 from a standstill, resulting in a collision with the preceding vehicle, since object detection sensor 7 has not detected preceding vehicle 25, therefore causing a collision.

However, since the preceding vehicle was already detected when it was still on the other side of detection limit 23, it is possible to identify no longer detectable object 25 as an object which is present but no longer detectable. For this purpose the object position and the relative motion of the object may be determined and extrapolated, thus allowing the approximate location of the invisible object to be determined.

Furthermore, distance controller 1 may store the information that a vehicle is present within detection limit 23, and that distance controller 1 is not able to automatically start host vehicle 20 as a result of activation of start confirmation element 9. However, since this may result in a situation in which the preceding vehicle exceeds detection limit 23 and enters the invisible region in the immediate vicinity of object detection sensor 7, but completes a turning maneuver so that this vehicle is no longer traveling in front of host vehicle 20, it would be possible for host vehicle 20 to safely accelerate. However, because the method according to the present invention has stored information that an object 25 is located within detection limit 23, the host vehicle is not automatically started, even after an activation of start confirmation element 9. In this case, transverse offset q of objects 24, 25, 26, which indicates the shortest distance of the objects from extended longitudinal axis 21 of the vehicle, is also determined. If a preceding vehicle turns or changes lanes, this transverse offset q assumes large positive or negative values, depending on which side the preceding vehicle is located. By specifying a suitable threshold value, a conclusion may be drawn that detected object 24, 25, 26 has turned or changed lanes when transverse offset q exceeds this threshold value. In this case it is recognized that the region in front of host vehicle 20 is unoccupied, and the host vehicle may be safely accelerated.

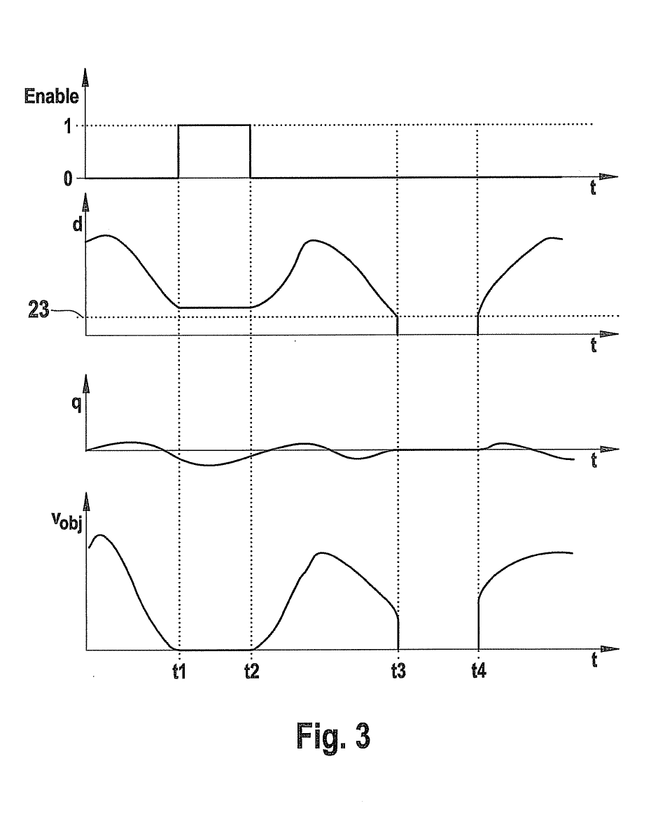

FIG. 3 shows a diagram illustrating multiple variables as a function of time. The lower diagram illustrates absolute velocity v_{obj} of the preceding vehicle as a function of time. It is shown that at point in time t1 the preceding vehicle remains at a standstill until point in time t2, whereupon it is again accelerated, and at point in time t3 the velocity abruptly drops to zero since the preceding vehicle is no longer detected. The preceding vehicle is not detected again until point in time t4, whereupon velocity v_{obj} of the preceding vehicle abruptly assumes values again.

This sequence is explained by the second diagram from the top, in which distance d of the preceding vehicle is likewise plotted as a function of time t. The deceleration of the preceding vehicle until point in time t1 also results in a decrease in distance d between the two vehicles. At point in time t1 both the preceding vehicle and the host vehicle are at a standstill, distance d between the vehicles being greater than detection limit 23. At point in time t2, at which both vehicles again start, distance d between the vehicles also increases until point in time t3 as a result of renewed braking of both vehicles, until distance d between the vehicles is so small that it falls below detection limit 23. Since the preceding vehicle is no longer detectable below this detection limit 23, distance d between the vehicles is recorded as zero, and it is no longer possible to determine object velocity v_{obj}. At point in time t4, distance d between the vehicles has once again increased until it exceeds detection limit 23, whereupon distance d between the vehicles as well as object velocity v_{obj} abruptly assume values.

The second diagram from the bottom likewise illustrates transverse offset q as a function of time, which indicates the magnitude of the deviation of the preceding vehicle from extended longitudinal axis 21 of host vehicle 20.

The top diagram shows an “enable” signal state, which indicates whether or not an automatic acceleration by distance controller 1 is possible at point in time t. As long as the “enable” signal is in state 1, an automatic start by distance controller 1 is possible via start confirmation element 9 after activation by the driver. As long as the “enable” signal is at zero, an automatic start by distance controller 1 is not possible, even when the driver has activated start confirmation element 9 for this purpose. The “enable” signal, which in state 1 enables an automatic start, is set to 1 when the host vehicle, which is behind a stopped preceding vehicle, has stopped, and no object 24, 25, 26 located in front is within the invisible region in the immediate vicinity of object detection sensor 7, i.e., below detection limit 23. As an example, this is illustrated during the period between points in time t1 and t2. On the other hand, if host vehicle 20 has stopped behind an object 24, 25, 26 located in front and one of objects 24, 25, 26 located in front has approached host vehicle 20 so closely that distance d thereof is smaller than minimum detection limit 23, this object is no longer detectable, and a start of vehicle 20 by distance controller 1 via activation of start confirmation element 9 should not be possible in this case as well, since this is associated with a high risk of collision because the object located in front is not detectable. In this case, which is illustrated between points in time t3 and t4 in the diagram of FIG. 3, according to the present invention no automatic starting process should be enabled, for which reason the “enable” signal remains at zero between points in time t3 and t4 even though the host vehicle has stopped behind a preceding vehicle. In this case, as illustrated between points in time t3 and t4, it may also be advantageous to actuate warning device 19 via an output signal 16 in principle, for example, when this driving state is present, or alternatively, only after the driver has pressed start confirmation element 9. This ensures that the driver is able to recognize that at this moment distance controller 1 is not enabled to start, so that the system is transparent to the driver and no assumed malfunction is suspected.

In the described cases, this function according to the present invention prevents distance controller 1 from carrying out an automatic starting process after an unintentional start confirmation 9 by the driver, by the fact that the history of the approach process is analyzed and taken into account. In the course of the approximation, the preceding vehicles are continuously observed, and in particular the trajectories thereof are analyzed for turning maneuvers by determining and evaluating the signal for transverse offset q. This tracking is also carried out for a nonactive driver assistance function, since the data must also be available upon initial startup. If in the course of a stopping process an object directly in front of the vehicle is “lost,” i.e., this object 24, 25, 26 is no longer detected by sensor system 7, and this object 24, 25, 26 has not carried out a turning maneuver because transverse offset q remains less than the predetermined threshold value, it is assumed that object 24, 25, 26, contrary to the sensor information, is still located directly in front of host vehicle 20. This information is stored, and is used in the case of an immediately subsequent starting process by distance controller 1 so that, contrary to the openly visible information from sensor system 7, no automatic starting process is carried out, but instead the driver of host vehicle 20 is correspondingly warned by actuation of warning device 19.

The situation illustrated in FIG. 3 shows the preceding vehicle, which has been decelerated to a standstill, and host vehicle 20, which likewise has stopped behind same. Even at a standstill, detected vehicle 24, 25, 26 is continuously detected by sensor system 7, so that an automatic starting process may be carried out by actuating and/or confirmation element 9 after driver confirmation 5. In the subsequent situation, between points in time t3 and t4 preceding vehicle 24, 25, 26 is “lost” by the sensor system during the stopping process. Since observed transverse offset q does not increase significantly shortly before the loss of detection, i.e., remains below the predetermined threshold values, a loss of detection, not a turning maneuver of object 24, 25, 26, is assumed because of the invisible region in the immediate vicinity of sensor 7. This situation may be unambiguously recognized using the stored history, and therefore a start release 5 mistakenly input by the driver through confirmation element 9 may be answered with a true message using warning device 19 instead of wrongly allowing the vehicle to start automatically.

1-11. (canceled)

12. A device for distance regulation of a host vehicle comprising:
an object detection sensor configured to detect at least one object located in front and regulate a velocity of the host vehicle in a sense of distance regulation; and
a distance controller configured to brake the host vehicle to a standstill;
wherein an object position relating to the at least one detected object which is no longer detected during a stopping process is stored, and a starting process of the vehicle is prevented until the object is detected again.

13. The device according to claim 12, wherein the object is no longer detected because it is located within an invisible region in an immediate vicinity of the object detection sensor.

14. The device according to claim 12, wherein the object position is stored by carrying out a tracking of a trajectory of the object located in front.

15. The device according to claim 12, wherein a starting process is not reactivated until the object is at a sufficient distance from the object detection sensor.

16. The device according to claim 12, wherein the vehicle is not started again until a driver activates at least one of an actuating and a confirmation element via which a driver's intention to start is signaled.

17. The device according to claim 12, wherein a transverse offset of the object located in front is determined by the object detection sensor.

18. The device according to claim 12, wherein a turning maneuver is detected when an absolute value of a transverse offset of the object located in front exceeds a predetermined threshold value.

19. The device according to claim 12, wherein a restarting process is not prevented when a turning maneuver of the object located in front has been detected.

20. The device according to claim 12, wherein tracking and turn detection are also carried out when the distance regulation is deactivated, so that current object data are already present when the distance controller is activated.

21. The device according to claim 12, further comprising:
a warning device configured to communicate to a driver that a start is not possible on account of being currently prevented by the distance controller.

22. A method for distance regulation of a host vehicle, the method comprising:
detecting at least one object located in front by an object detection sensor;
regulating a velocity of the host vehicle in a sense of distance regulation;
braking the host vehicle to a standstill by a distance controller;
storing an object position relating to the at least one detected object which is no longer detected during a stopping process; and
preventing a starting process of the vehicle until the object is detected again.
